(19) United States
(12) Patent Application Publication
(10) Pub. No.: US 2019/0098366 A1
(43) Pub. Date: Mar. 28, 2019

(54) Electronic Programme Guide Media System and Method

(71) Applicant: Promomii Limited, London (GB)

(72) Inventors: Michael Maximilian Moss, London (GB); Daniel Halasz, London (GB); Tigran Mnatsakanyan, London (GB)

(21) Appl. No.: 16/141,441

(22) Filed: Sep. 25, 2018

(30) Foreign Application Priority Data
Sep. 25, 2017 (GB) 1715475.8

(51) Int. Cl. H04N 21/482; G06F 17/30; H04N 21/2743; H04N 21/4402; H04N 21/2343

(52) U.S. Cl. CPC H04N 21/4828; G06F 17/30106; H04N 21/234309; H04N 21/44029; H04N 21/2743

(57) ABSTRACT

An electronic programme guide, EPG, media system (10) and a computer implemented media provision method for an electronic programme guide are disclosed. The system (10) comprises a data repository (20), a metadata repository (30), a media server (40) and a processor. The data repository (20) stores an encoded video file corresponding to each of a plurality of media assets and the metadata repository (30) stores metadata on each media asset linked to the encoded video file corresponding to the respective media asset. In response to the system (10) receiving a metadata query from an EPG (100) of a remote user device, a media item matching the metadata query is determined from the metadata in the metadata repository (30) and a link to the corresponding encoded video file is generated and communicated to the EPG (100). The link is operable to cause the media server (40) to serve the encoded video file to the remote user device for display as part of the EPG (100).

### CROSS-REFERENCE TO RELATED APPLICATION

This application is based on and claims priority to GB Patent Application No. 1715475.8, filed 25 Sep. 2017, the contents of which are incorporated by reference in its entirety as if set forth herein.

### FIELD OF THE INVENTION

The present invention relates to an electronic programme guide media system and method that are particularly applicable in enhancing operation of electronic programme guides.

### BACKGROUND TO THE INVENTION

An Electronic Programme Guide (EPG) is used in televisions and devices such as set-top boxes, digital video recorders and the like to provide the user and the device with detailed information relevant to program listings. Typically these are displayed in a manner that is easily understood and conveys the maximum amount of information to the user on current and future programmes. With the advent of on-demand services, EPGs in some instances are used to convey information on future episodes or on related programmes, films etc. EPG data may also be used for functions such as scheduling recordings, series links and the like.

One popular way of providing an EPG for scheduled broadcasts is a display in the form of a grid guide with channels being represented by rows in the guide and time in columns (typically EPGs are divided into 1 hour slots so that the user can understand when something starts and finishes relative to a particular hour of the clock). In the case of on-demand services, these too tend to use grid guides with rows representing a particular series, genre or other grouping of programmes.

A particular challenge with EPGs is in the balance of information—the more information displayed about a particular episode, programme, film (referred to hereafter as media items) or the like, the less screen estate is available to display listings for other channels or future times. Generally, the attitude taken in EPGs is to limit information on particular media items to allow maximal listings to be displayed in the grid guide. However, so as to be able to provide the user with the wealth of information on the media items, an EPG typically has a detailed information option that can be activated by an action in the grid guide or by a button press on a remote control or a similar action whilst the user has focused a control element over the respective media item in the grid guide. This typically produces a pop-up window or further screen in which details on the media item (such as summary, actor listing, age classification etc) is shown.

### STATEMENT OF INVENTION

According to an aspect of the present invention, there is provided an electronic programme guide media system comprising a data repository, a metadata repository, a media server and a query interface,

the data repository storing an encoded video file corresponding to each of a plurality of media assets and the metadata repository storing metadata on each media asset linked to the encoded video file corresponding to the respective media asset;
the query interface being responsive to a metadata query from an EPG to determine media item matching the metadata query from the metadata in the metadata repository and provide a link to the corresponding encoded video file,
wherein the link is operable to cause the media server to serve the encoded video file for display as part of an EPG.

In embodiments of the present invention, video files such as promotional teasers, advertisements or other media or multimedia assets are collated in a media repository and served based on a metadata query in a form for inclusion within an EPG. In preferred embodiments, an appropriately encoded version of the media item is served from a number of differently encoded versions of the media item.

The asset need not be restricted to video and could be or include other formats or media types including executable assets, 3D or augmented reality representations, for example. The repository may be centralized, distributed, peer-to-peer or some combination. Metadata on the media asset that is the subject of or is associated with the video file is stored in the metadata repository linked to the video file. When a query on metadata is received matching to a media asset, a match is made in the metadata repository and a link to the corresponding video file is returned for inclusion in an EPG. When circumstances defined by the EPG are satisfied (this may be user interaction, it may always be satisfied, it may be time sensitive and only trigger on certain times/dates, etc.), the video file is requested via the link and served by the media server for display as part of the EPG.

In preferred embodiments, the electronic programme guide media system includes a media collation system in which video files on media assets from multiple providers are obtained or otherwise collated and uploaded to the data repository. The media collation system may be arranged to generate a number of differently encoded versions of the video files and upload them to the data repository. The media collation system may be further arranged to obtain and/or populate metadata in the metadata repository.

The query interface may be responsive to queries based directly or indirectly on the metadata. For example, it may look to match against genre, series, actor, director or the like or it may be arranged to apply fuzzy logic matching, machine learning or other approaches to return matches that are deemed close within tolerances set by a fitness function or some other optimization criteria. The query interface may also be responsive to queries by an identifier for media assets such that a specific media asset can be requested via identifier.

### BRIEF DESCRIPTION OF THE DRAWINGS

Embodiments of the present invention will now be described by way of example only with reference to the accompanying drawings in which:

FIG. 1 is a schematic diagram of an electronic programme guide media system according to an embodiment of the present invention;

FIG. 2 is a schematic diagram illustrating data flow in the system of FIG. 1;

FIG. 3 is a schematic diagram of an electronic programme guide media system according to another embodiment of the present invention;

### DETAILED DESCRIPTION

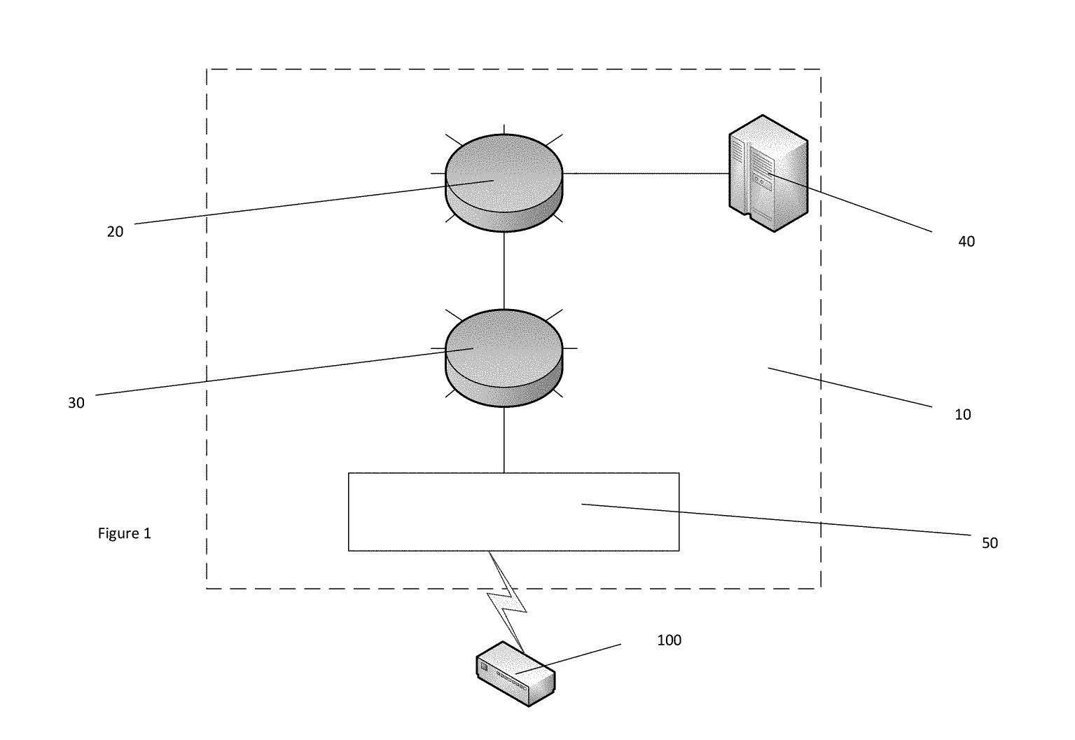

FIG. 1 is a schematic diagram of an electronic programme guide media system 10 according to an embodiment of the present invention.

The electronic programme guide media system 10 includes a data repository 20, a metadata repository 30, a media server 40 and a query interface 50.

The data repository 20 stores an encoded video file corresponding to each of a plurality of media assets. The metadata repository 30 stores metadata on each media asset linked to the encoded video file corresponding to the respective media asset.

The query interface 50 is arranged to receive a metadata query from a remote EPG 100. The query interface determines a media item matching the metadata query from the metadata in the metadata repository 30 and provides the remote EPG 100 a link to the corresponding encoded video file. The remote EPG 100 uses the link to cause the media server 40 to serve the encoded video file from the data repository 30 for display as part of the remote EPG 100.

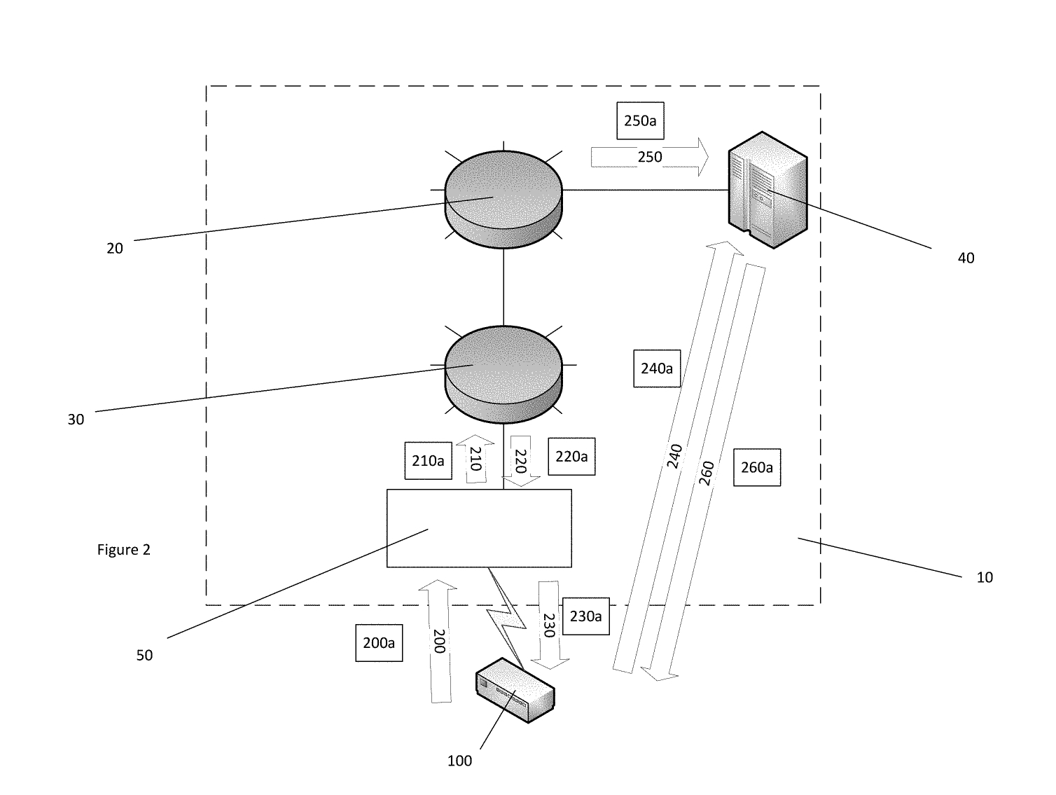

FIG. 2 is a schematic diagram illustrating data flow in the system of FIG. 1.

In step 200, a remote EPG 100 detects user interface focus over an EPG entry for a TV programme, composes a query 200a based on metadata held by the remote EPG 100 and sends this to the electronic programme guide media system 10.

In step 210, the query 200a is received at the electronic programme guide media system 10 by the query interface 50. The query is translated into a match operation 210a and applied against the metadata repository 30.

In step 220, a link 220a is obtained from the metadata repository for video file in the data repository 20 for a matched media asset by the query interface 50.

In step 230, a media server link 230a is composed from the link 220a and communicated to the remote EPG 100. The media server link 230a includes an address of the media server 40 and a designation of the link to the video file such that the media server 230a when communicated via the media server link 230a is able to determine the video file being requested.

In step 240, the remote EPG 100 communicates a request 240a to the media server link 230a. In step 250, upon receiving the request, the media server 40 obtains the encoded video file 250a from the data repository 20 and serves the video file 260a, preferably by streaming, in step 260 to the remote EPG 100.

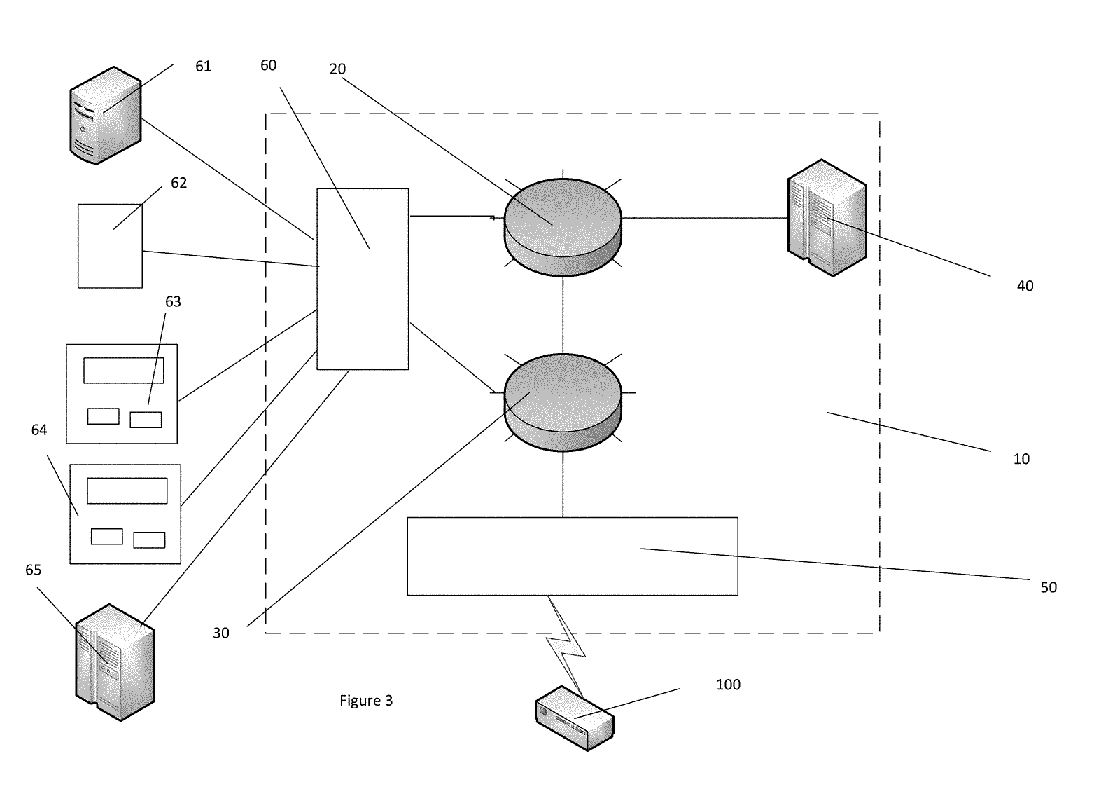

FIG. 3 is a schematic diagram of an electronic programme guide media system according to another embodiment of the present invention.

In this embodiment, the electronic programme guide media system 10 includes a media collation system 60. The media collation system 60 obtains or otherwise collates video files on media assets from multiple providers and uploads these to the data repository 20. Retrieval may be automated from providers 61 (either by the provider giving access to their databases or by scraping content from their websites etc), retrieval from an upload folder 62 where media files may be left or via manual upload 63 accessible by providers. The automated operations may operate in substantially real-time or subject to a schedule (such as overnight).

The media collation system may optionally transcode a number of differently encoded versions (for example, different codecs, different compression, different bitrates etc) of the video files and upload them to the data repository 20. Optionally, operation of the transcoder may be monitored and/or evaluated such that only successful transcoding or transcoding that produces video files with a predetermined quality (noise, sound or video quality etc may be measured) is accepted. Repeated transcoding (with or without changes to transcoding parameters, codecs etc) may be attempted where transcoding is deemed to have failed.

In one embodiment, media is transcoded into two sets (HLS for iOS and Flash for Android/Web) of three separate video streams (Stream Master—High, Mid and Low) for Adaptive Bit Rate (ABR) streaming.

Quality control of transcoding may be automated to check quality and for any errors in transcoding—where quality is not sufficient, transcoding may be reattempted and if still failing flagged for manual review/fix.

Where multiple differently encoded versions are stored in the data repository, the media server 40 or query interface 50 may determine an appropriate version to serve to a remote EPG (for example based on machine/OS identifier or similar in header information or provided by the remote EPG system or by maintaining a table cross-referencing remote EPG or EPG type and transcoded version type to be served). Alternatively or additionally, the query interface may include options for the remote EPG to designate bandwidth, quality etc. of media which the system 10 takes into account. In another alternative, the transcoded version may be dynamically managed by the media server 40 responsive to delivery timing and, where applicable, acknowledgements from the remote EPG system so as to provide the optimal version of the media item (and switch to a lower or higher bitrate or compressed version as bandwidth and network conditions dictate).

The media collation system preferably also obtains and/or populates metadata in the metadata repository 30. The metadata may be retrieved from the providers systems 60, input via manual entry 64 and/or obtained from remote sources 65 such as EPG providers, TV listings, bloggers etc. Multiple sources may be queried such that the provider's metadata is refined and/or enhanced by addition from external sources. Metadata stored may also include data on consumption of the media asset or video files or on references to the media asset or video file in social media, for example. Metadata may be obtained, for example, in an XML Sidecar and translated (using a schema associated with the source) into a predetermined Metadata format and imported to the metadata repository 30.

In addition to responding with matched video files for requested media assets/metadata, in preferred embodiments the system 10 may also provide a promotional stream of video files for output in an EPG or other interface. Preferably the promotional stream is filtered so as to include only those corresponding to media assets airing in the next 24 hours (determined from programme listings). Preferably the system 10 is pre-advised or is able to query the EPG for the channels it handles and filters the promotional stream to assets from those channels in the next 24 hours. The query interface may be configured to offer different streams depending on API calls—for example, the remote EPG may be able to request the top N media assets matching a genre or for a particular channel.

Preferably, machine learning may be used as part of the metadata matching by the query interface 50 so as to improve relevance of non-exact matches. Analytics and learning may also monitor consumption of video files, whether it is played to the end, patterns of video files requested etc. Data from analytics will enable provision of reports to broadcasters on how many views their promos are getting, if people view them all the way through and if not, where do they stop. If two promos have been cut for the same show, which one is performing better? If a digital platform has a member base where users have volunteered personal information, then broadcasters will be able to see how old the viewer of the promos are, their gender, where they live, what their interests are. Furthermore, tracking may be possible using cookies and the like. Where has the viewer been on the internet before they watched the promo? Which sites did they go to afterwards? Based on their internet habits, the system can direct to them media items they might like. Using IP address matching, in some embodiments it is possible to measure conversion. Did the person who just saw a promo the go on to watch the show?

It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

It will be appreciated that the data repository may take various forms including a central or distributed file store, database (such as SQL or other relational or non-relational database types). It may be implemented using storage devices such as hard disks, random access memories, solid state disks or any other forms of storage media. It will also be appreciated that the processor discussed herein may represent a single processor or a collection of processors acting in a synchronised, semi-synchronised or asynchronous manner.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. An electronic programme guide, EPG, media system comprising a data repository, a metadata repository, a media server and a processor,
the data repository storing an encoded video file corresponding to each of a plurality of media assets and the metadata repository storing metadata on each media asset linked to the encoded video file corresponding to the respective media asset;
the processor configured to execute computer program code for executing a query interface, including:
computer program code configured, in response to the system receiving a metadata query from an EPG of a remote user device, to determine a media item matching the metadata query from the metadata in the metadata repository;
and computer program code configured to generate a link to the corresponding encoded video file and communicate the link to the remote user device,
wherein the link is operable to cause the media server to serve the encoded video file to the remote user device for display as part of the EPG.

2. The system of claim 1, wherein the metadata repository is configured to match metadata to a media item in dependence on the subject of the media asset.

3. The system of claim 1, wherein the metadata repository is configured to match metadata to a media item in dependence on the metadata specifying the media asset.

4. The system of claim 1, further comprising computer program code configured to cause the query interface to provide a link to the corresponding encoded video file upon one or more predetermined conditions being satisfied, the one or more predetermined conditions specifying one or more of a point in time, a time or date range, an event or a user activity.

5. The system of claim 1, wherein the link encodes or references a predetermined condition and is operable to cause the media server to serve the encoded video file upon the predetermined condition being satisfied, the one or more predetermined condition specifying one or more of a point in time, a time or date range, an event or a user activity.

6. The system of claim 1, further comprising a media collation system configured to automatically obtain video files on the plurality of media assets from multiple remote sources and upload the video files to the data repository.

7. The system of claim 1, further comprising a media collation system configured to receive video files uploaded via a user interface on the plurality of media assets and upload the video files to the data repository.

8. The system of claim 6, wherein the media collation system is configured to generate a plurality of differently encoded versions of each video file and upload them to the data repository.

9. The system of claim 7, wherein the media collation system is configured to generate a plurality of differently encoded versions of each video file and upload them to the data repository.

10. The system of claim 6, wherein the media collation system includes a processor configured to execute computer program code to transcode each video file to produce a differently encoded version.

11. The system of claim 10, wherein the processor is configured to execute computer program code to transcode each video file to change one or more of the video's codec, compression and bitrate.

12. The system of claim 7, wherein the media collation system includes a processor configured to execute computer program code to transcode each video file to produce a differently encoded version.

13. The system of claim 12, wherein the processor is configured to execute computer program code to transcode each video file to change one or more of the video's codec, compression and bitrate.

14. The system of claim 10, wherein the media collation system includes a processor configured to execute computer program code to monitor operation of the transcoding and accept only transcoded video files having a predetermined quality for upload to the data repository.

15. The system of claim 6, wherein the media collation system is configured to obtain metadata on the media asset and write the obtained metadata in the metadata repository.

16. The system of claim 7, wherein the media collation system is configured to obtain metadata on the media asset and write the obtained metadata in the metadata repository.

17. The system of claim 1, further comprising computer program code configured to cause the query interface to perform one or more of fuzzy logic matching or machine learning to determine matches that are within tolerances set by a predetermined fitness function or that satisfy predetermined optimization criteria.

18. A computer implemented media provision method for an electronic programme guide, EPG, the method comprising:
encoding, in a video data repository an encoded video file corresponding to each of a plurality of media assets;
encoding in a metadata data repository metadata on each media asset linked to the encoded video file corresponding to the respective media asset;
executing a query interface, by a processor, including:
executing, by the processor, computer program code to determine a media item matching the metadata query from the metadata in the metadata repository in response to receiving a metadata query from an EPG of a remote user device;
executing, by the processor, computer program code to generate a link to the corresponding encoded video file; and
executing, by the processor, computer program code to communicate the link to the remote user device,
wherein the link is operable to cause the media server to serve the encoded video file to the remote user device for display as part of the EPG.
